(19) United States
(12) Patent Application Publication
(10) Pub. No.: US 2024/0013080 A1
(43) Pub. Date: Jan. 11, 2024

(54) SIZING FOR QUANTUM SIMULATION

(71) Applicant: Dell Products L.P., Round Rock, TX (US)

(72) Inventors: Rômulo Teixeira de Abreu Pinho, Niteroi (BR); Benjamin E. Santaus, Somerville, MA (US); Brendan Burns Healy, Whitefish Bay, WI (US); John Richelieu Boisseau, Austin, TX (US)

(21) Appl. No.: 17/811,199

(22) Filed: Jul. 7, 2022

(51) Int. Cl. G06N 10/20; G06N 10/80; G06N 10/60

(52) U.S. Cl. CPC G06N 10/20; G06N 10/80; G06N 10/60

(57) ABSTRACT

One example method includes receiving parameter values relating to execution of a simulation of a quantum algorithm, deriving quantum attributes from the parameter values, generating, based on the quantum attributes, a classical computing resource prediction, and translating the classical computing resource prediction into elements of a classical computing infrastructure. The classical computing infrastructure may be sized and configured to support computationally efficient, and cost efficient, execution of the simulation of the quantum algorithm.

### RELATED APPLICATION

This application is related to U.S. patent application Ser. No. 17/648,065, entitled INTELLIGENT ORCHESTRATION OF CLASSIC-QUANTUM COMPUTATIONAL GRAPHS, filed 14 Jan. 2022, and incorporated herein in its entirety by this reference.

### FIELD OF THE INVENTION

Embodiments of the present invention generally relate to quantum computing. More particularly, at least some embodiments of the invention relate to systems, hardware, software, computer-readable media, and methods for determining how much classical infrastructure is needed to support the performance of quantum computing simulations.

### BACKGROUND

While access to real quantum computing hardware remains limited and NISQ (noisy intermediate-scale quantum) computers suffer from technical limitations, quantum simulations on classical infrastructures are currently playing, and will continue to play, an important role to allow companies to experiment with quantum algorithms in controlled and relatively lower cost environments. A significant unsolved problem for users of these environments is how much classical infrastructure to procure to satisfy their quantum simulation demands.

In particular, the amount of computational resources to run quantum algorithms is currently not known a priori. Moreover, procuring the wrong amount of resources for quantum workloads may lead to computation and cost inefficiencies. That is, procuring too few resources may prevent efficient performance of quantum simulations, and procuring too many resources may result in unnecessary expenditures.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture according to some example embodiments.

FIG. 2 discloses aspects of a method according to some example embodiments.

FIG. 3 discloses aspects of an example computing entity that may be operable to perform any of the disclosed methods, processes, and operations.

### DETAILED DESCRIPTION OF SOME EXAMPLE EMBODIMENTS

Embodiments of the present invention generally relate to quantum computing. More particularly, at least some embodiments of the invention relate to systems, hardware, software, computer-readable media, and methods for determining how much classical infrastructure is needed to support the performance of quantum computing simulations.

In general, example embodiments of the invention are concerned with approaches for determining an amount of classical infrastructure needed to support quantum computing simulations, that is, the running of a quantum algorithm on classical infrastructure. Classical infrastructure may be preferred over quantum computing resources as quantum computing resources may be relatively scarce, and are expensive in any case. While classical infrastructure is less expensive to procure and use than quantum infrastructure, there is still an interest in accurately determining how much classical infrastructure is needed so as to ensure that neither too much, nor too little, classical infrastructure is provided. For example, although pay-per-use models such as Dell Technologies APEX offer more flexibility in the hardware procurement process, knowing beforehand the right amount of computational resources required for quantum computing simulations may enable customers to reduce their costs.

Thus, at least some example embodiments of the invention are directed to mechanisms for sizing quantum simulation infrastructure, that is, classical infrastructure needed to run quantum simulations, from simple parameters extracted from the quantum algorithms that are to be run on the quantum simulation infrastructure. An intelligent sizing engine according to some embodiments may operate to leverage a resource consumption prediction model that is capable of predicting the amount of classical resources to be consumed by a quantum algorithm running on top of a simulation engine.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may enable a user to accurately determine an amount of classical computing resources needed to run a quantum computing simulation. An embodiment may help to ensure cost-efficient performance of quantum computing simulations, that is, a simulation in which a quantum algorithm is run on a classical computing infrastructure. An embodiment may help to ensure computationally-efficient performance of quantum computing simulations. An embodiment of the invention may help to avoid over, and under, procurement of classical computing resources for supporting quantum computing simulations. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of an Example Architecture and Environment

The following is a discussion of aspects of example operating environments for various embodiments of the invention. This discussion is not intended to limit the scope of the invention, or the applicability of the embodiments, in any way.

A.1 Interface—General Aspects

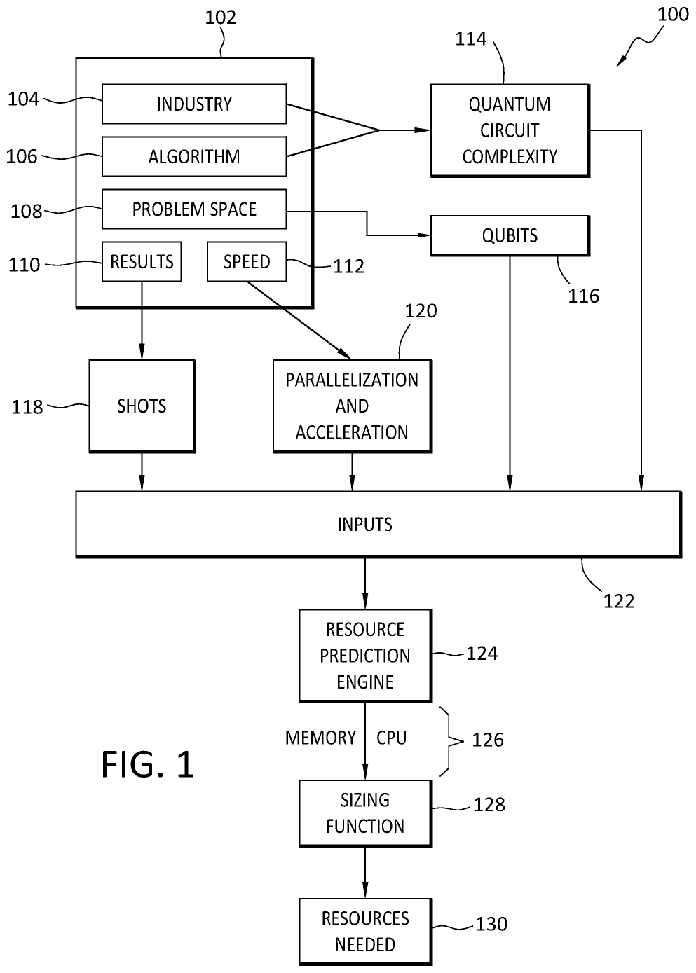

With particular attention now to FIG. 1, one example of an architecture according to some embodiments of the invention is denoted generally at 100. The architecture 100 may include a user interface 102, which may comprise any hardware and/or software operable to receive input signals from a user that may or may not be a human. Some example user interfaces 102 include, but are not limited to, a GUI (graphical user interface) and a CLI (command line interface). In general, the user interface 102 may be operable to receive user input concerning one or more quantum computing simulations that are to be run on classical, that is, non-quantum, computing infrastructure. The input received by way of the user interface 102 may, ultimately, be used by embodiments of the invention to determine an amount of computing resources, which may comprise hardware and/or software, needed to perform quantum computing simulations, that is, execution of a quantum algorithm identified by a user, on a classical computing infrastructure.

The provision of input to the user interface 102 may be prompted by the display, and/or other presentation, of various user-selectable items. By providing the information prompted for by the user interface 102, a user may thus provide the information needed to enable a determination of the amount of classical computing resources needed to support performance of a quantum computing simulation, such as may be defined by the user, in part or in whole through use of the user interface 102.

In the example of FIG. 1, a user may be prompted by a user interface 102 to provide information such as, but not limited to, industry information 104, the quantum algorithm 106, or simply an ‘algorithm,’ that is to be executed on classical computing resources, the size of the problem space 108, a required robustness of the results 110 of the execution of the quantum algorithm 106, and a desired speed 112, among a group of selectable tiers such as slow, medium, and fast, of the execution of the quantum algorithm 106. With respect to the speed 112, it is noted that there may be some trade-offs for other factors, such as cost or reliability for example. The following examples are illustrative.

### A.2 Interface—Example Operational Aspects

As noted, example embodiments may provide a user interface 102 that may enable a user to provide various inputs, such as parameter values for example, which may be used to determine classical computing resources needed to support execution of a quantum algorithm. For example, the user interface 102 may enable a user to select, or specify, the type of quantum algorithm 106 to be executed. As well, the user interface 102 may enable a user to select the target industry 104 of the application with which the quantum algorithm 106 is concerned. Example target industries may include, but are not limited to, pharma, logistics, and finance.

Next, the user interface 102 may enable the user to select the type of quantum algorithm 106 to be executed. For example, a user may select a VQE (variational quantum eigensolver) algorithm for a use in a pharma application, or a user may select a QAOA (quantum approximate optimization algorithm) for a logistics application. If the user does not specify a quantum algorithm 106 type for some reason, some embodiment may automatically select an “average” algorithm 106 for the given industry 104.

After the industry 104 and algorithm 106 have been identified, the user interface 102 may enable the user to specify the expected size of the problem space 108, that is, the size of the space that encompasses the possible solutions to the problem that is being modeled by the algorithm 106. For example, and as discussed further below, combinatorial problems, such as may be encountered in logistics applications, may have a problem space that grows exponentially with size of the input. As a result, the problem space size for a problem with input size N may be represented by log(N) qubits.

More particularly, a user may specify a problem space size 108 in various ways. For example, if a user is aware of quantum algorithm concepts, the user may provide a range of the number of qubits of the algorithms that the user aims to run. As another example, a user may specify, for instance, the number of assets to be considered in a financial problem, or the fleet size in a logistics problem, and the user interface 102 may operate to translate the problem space size into an expected number of qubits needed to represent the problem space, that is, the number of qubits expected to be needed to run the algorithm 106 given, at least, the problem space size 108.

As a final example, the user interface 102 may enable a user to provide the required robustness of the results 110 to be obtained by execution of the algorithm 106, and the expected speed of execution 112 of the algorithm 106. In some embodiments, the user interface 102 may offer various user-selectable options, such as {Low, Medium, High} for example, for each of the parameters 110 and 112.

A.3 Parameter Effects on Hardware Determinations

With continued reference to the example of FIG. 1, the choice of industry 104 and algorithm type 106 may determine the expected complexity 114 of the quantum circuits associated with the quantum algorithms. Such complexity 114 may be associated with, for example, the depth, or number of steps, of the quantum circuit.

The number of qubits 116 relates to the size of the problem space 108. For example, combinatorial problems, such as those in logistics, may have a problem space 108 that grows exponentially with size of the input. As a result, a hypothetical problem with input size ‘N’ may be represented as having a size equal to log(N) qubits.

The robustness of results 110 relates to the number of times (shots 118) an algorithm 106 needs to be executed so that signal can be extracted from the inherent noise of quantum algorithms. Finally, the speed of execution 112 indicates how much parallelization and acceleration 120 will be necessary to execute the algorithms within the required times.

Input 122 comprising, but not limited to, the shots 118, parallelization and acceleration 120, number of qubits 116, and quantum circuit complexity 114, may be provided to a resource prediction engine 124, examples of which are disclosed in the ‘Related Application’ referred to herein. The resource prediction engine 124 may process the inputs 122, such as by running one or more algorithms, and output information 126 concerning aspects of the classical infrastructure expected to be needed to efficiently run the algorithm 106. Such output 126 may comprise, for example, memory and CPU requirements.

The output 126 of the resource prediction engine 124 may, in turn, be provided as an input to a sizing function 128, which may be incorporated into a sizing engine for example. The sizing function 128 may operate to translate the output 126 of the resource prediction engine 124 into, for example, a number of physical computing systems that are required for execution of the algorithm(s) 106 selected by a user. More generally, the sizing function 128 may output the type and amount of classical computing infrastructure resources 130 needed for execution of the algorithm(s) 106. In some embodiments, the sizing function 128 may be incorporated into the resource prediction engine 124, or vice versa, but no particular configuration or arrangement of the sizing function 128 or resource prediction engine 124 is required. In some embodiments, the sizing function 128 and resource prediction engine 124 may be implemented as separate and discrete computing entities. Further, some example embodiments may omit the resource prediction engine 124.

As noted herein, the classical computing infrastructure resources 130 that are identified by example embodiments may be such as to enable cost-efficient performance of the algorithm(s) 106, as well as to enable computationally-efficient performance of the algorithm(s) 106. In this way, example embodiments may reduce, or avoid, procurement of too few, or too many, computing resources needed to execute quantum algorithm simulations on classical infrastructure.

### B. Example Methods

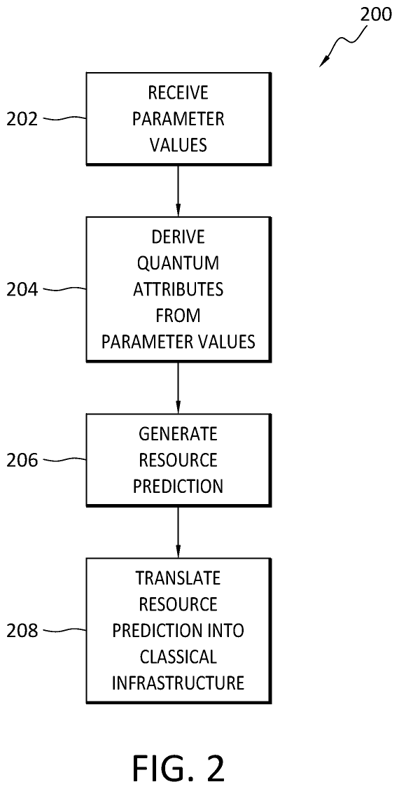

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, one example method according to some embodiments is denoted generally at 200. Part or all of the example method 200 may be performed by a combination of computing entities comprising a resource prediction engine and a sizing function, although that is not necessarily required. In some embodiments, at least part of the method 200 may be performed solely by the sizing function 128. Thus, the scope of the invention is not limited to the example method, and example functional allocation amongst computing entities, disclosed in connection with FIG. 2.

The example method 200 may begin with the receipt 202 of various parameter values, and other information, from a user, such as by way of a user interface for example. Such parameter values and information may comprise, for example, industry information, the type of algorithm whose execution is to be simulated on a classical computing infrastructure, the size of the problem space implied by the algorithm and industry information, desired robustness of results generated by execution of the quantum algorithm, and a desired speed for performance of the quantum algorithm.

Based on the input that has been received 202, various quantum attributes may be derived 204. For example, quantum attributes such as, but not limited to, the number of shots, parallelization and acceleration, number of qubits, and quantum circuit complexity, may be determined, directly or indirectly, from the received input 202.

Next, the quantum attributes may be provided as input, such as to a resource prediction engine, which may then generate 206 a resource prediction based on the quantum attributes. In general, the resource prediction may indicate an amount and type resources, such as memory and CPU for example, needed to run the algorithm. The resource prediction information may be relatively granular in that it may not specify the type and number of actual computing entities needed to run the algorithm, but may instead simply specify raw amounts of the basic resources, such as memory and CPU, needed.

The raw resource information generated at 206 may then be provided as an input to a sizing function. The sizing function may translate 208 the raw resource information into a classical computing infrastructure configuration. For example, the sizing function may generate output that indicates how many physical computing entities are needed to perform the algorithm, given the various constraints and inputs initially provided 202, and the raw amounts that have been determined 206.

In some embodiments, a user or other entity may provide, to the sizing function, the type and number of computing systems available so as to help ensure that the sizing function maps the raw resource information to assets that are actually available, or will be, when the algorithm is to be run. Because the assets actually available may not track precisely with the raw resource information, it may be possible in some cases that somewhat more, or fewer, classical computing resources are available for execution of the algorithm than would be optimal. Thus, the sizing function may be configured to default, for example, to the type and number of classical computing resources that most closely fit the raw resource information. Another default may be for the sizing function to specify no less than the amount of classical computing resources, leaving open the possibility that the sizing function may specify a fail-safe amount of more classical computing resources than are actually expected to be needed. Thus, as between two different amounts of classical computing resources, one which is less than what is needed, and one which is more than is needed, the sizing function may default to the latter. In any case, a default may be specified to prioritize, should the need arise, computational efficiency over cost efficiency, or vice versa.

### C. Further Discussion

As will be apparent from this disclosure, example embodiments of the invention may possess various useful features and aspects. For example, embodiments may implement and use a mechanism operable to size the required classical infrastructure to run quantum algorithms on top of simulation engines. As another example, an embodiment may operate to translate application-level concepts into quantum algorithm parameters. As a final example, embodiments may employ a resource consumption prediction engine that may operate based on various quantum algorithm parameters.

### D. Further Example Embodiments

Following are some further example embodiments of the invention. These are presented only by way of example and are not intended to limit the scope of the invention in any way.

Embodiment 1. A method, comprising: receiving parameter values relating to execution of a simulation of a quantum algorithm; deriving quantum attributes from the parameter values; generating, based on the quantum attributes, a classical computing resource prediction; and translating the classical computing resource prediction into elements of a classical computing infrastructure.

Embodiment 2. The method as recited in embodiment 1, wherein the parameter values relate to any one or more of the following parameters: industry; quantum algorithm; problem space size; robustness of results expected from execution of the quantum algorithm; and, a speed of execution of the quantum algorithm in the classical computing infrastructure.

Embodiment 3. The method as recited in embodiment 2, wherein the industry and the quantum algorithm collectively determine, at least in part, a quantum circuit complexity.

Embodiment 4. The method as recited in embodiment 2, wherein the problem space size determines, at least in part, a number of qubits associated with execution of the quantum algorithm.

Embodiment 5. The method as recited in embodiment 2, wherein the robustness of results determines, at least in part, a number of shots associated with execution of the quantum algorithm.

Embodiment 6. The method as recited in embodiment 2, wherein the speed of execution determines, at least in part, a need for parallelization and acceleration in execution of the quantum algorithm.

Embodiment 7. The method as recited in any of embodiments 1-6, wherein the classical computing resource prediction comprises raw classical computing resource information.

Embodiment 8. The method as recited in embodiment 7, wherein the raw classical computing resource information comprises information that specifies a number of central processing units (CPU), and further specifies an amount of memory.

Embodiment 9. The method as recited in any of embodiments 1-8, wherein the elements of a classical computing infrastructure comprise a number of physical computing entities needed to execute a simulation of the quantum algorithm.

Embodiment 10. The method as recited in any of embodiments 1-9, wherein user-selectable parameters to which the parameter values respectively correspond are presented to a user by way of a user interface.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

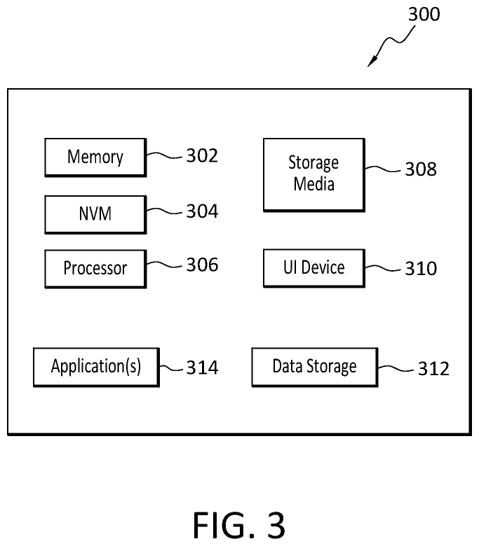

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300, and which may comprise classical computing infrastructure. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, a UI (user interface) device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving parameter values relating to execution of a simulation of a quantum algorithm;
deriving quantum attributes from the parameter values;
generating, based on the quantum attributes, a classical computing resource prediction; and
translating the classical computing resource prediction into elements of a classical computing infrastructure.

2. The method as recited in claim 1, wherein the parameter values relate to any one or more of the following parameters: industry; quantum algorithm; problem space size; robustness of results expected from execution of the quantum algorithm; and, a speed of execution of the quantum algorithm in the classical computing infrastructure.

3. The method as recited in claim 2, wherein the industry and the quantum algorithm collectively determine, at least in part, a quantum circuit complexity.

4. The method as recited in claim 2, wherein the problem space size determines, at least in part, a number of qubits associated with execution of the quantum algorithm.

5. The method as recited in claim 2, wherein the robustness of results determines, at least in part, a number of shots associated with execution of the quantum algorithm.

6. The method as recited in claim 2, wherein the speed of execution determines, at least in part, a need for parallelization and acceleration in execution of the quantum algorithm.

7. The method as recited in claim 1, wherein the classical computing resource prediction comprises raw classical computing resource information.

8. The method as recited in claim 7, wherein the raw classical computing resource information comprises information that specifies a number of central processing units (CPU), and further specifies an amount of memory.

9. The method as recited in claim 1, wherein the elements of a classical computing infrastructure comprise a number of physical computing entities needed to execute a simulation of the quantum algorithm.

10. The method as recited in claim 1, wherein user-selectable parameters to which the parameter values respectively correspond are presented to a user by way of a user interface.

11. A non-transitory storage medium having stored therein instructions that are executable by one or more hardware processors to perform operations comprising:
receiving parameter values relating to execution of a simulation of a quantum algorithm;
deriving quantum attributes from the parameter values;
generating, based on the quantum attributes, a classical computing resource prediction; and
translating the classical computing resource prediction into elements of a classical computing infrastructure.

12. The non-transitory storage medium as recited in claim 11, wherein the parameter values relate to any one or more of the following parameters: industry; quantum algorithm; problem space size; robustness of results expected from execution of the quantum algorithm; and, a speed of execution of the quantum algorithm in the classical computing infrastructure.

13. The non-transitory storage medium as recited in claim 12, wherein the industry and the quantum algorithm collectively determine, at least in part, a quantum circuit complexity.

14. The non-transitory storage medium as recited in claim 12, wherein the problem space size determines, at least in part, a number of qubits associated with execution of the quantum algorithm.

15. The non-transitory storage medium as recited in claim 12, wherein the robustness of results determines, at least in part, a number of shots associated with execution of the quantum algorithm.

16. The non-transitory storage medium as recited in claim 12, wherein the speed of execution determines, at least in part, a need for parallelization and acceleration in execution of the quantum algorithm.

17. The non-transitory storage medium as recited in claim 11, wherein the classical computing resource prediction comprises raw classical computing resource information.

18. The non-transitory storage medium as recited in claim 17, wherein the raw classical computing resource information comprises information that specifies a number of central processing units (CPU), and further specifies an amount of memory.

19. The non-transitory storage medium as recited in claim 11, wherein the elements of a classical computing infrastructure comprise a number of physical computing entities needed to execute a simulation of the quantum algorithm.

20. The non-transitory storage medium as recited in claim 11, wherein user-selectable parameters to which the parameter values respectively correspond are presented to a user by way of a user interface.
